(19) United States
(12) Patent Application Publication
(10) Pub. No.: US 2024/0286683 A1
(43) Pub. Date: Aug. 29, 2024

(54) VEHICLE SUBSTRUCTURE

(71) Applicant: HONDA MOTOR CO., LTD., Tokyo (JP)

(72) Inventors: Masahiro ABIKO, Tokyo (JP); Ken SATOH, Tokyo (JP); Takehiro KONDO, Tokyo (JP); Tatsuya Suzuki, Tokyo (JP)

(21) Appl. No.: 18/584,015

(22) Filed: Feb. 22, 2024

(30) Foreign Application Priority Data
Feb. 24, 2023 (JP) 2023-027165

(51) Int. Cl. B62D 21/15; B62D 21/02

(52) U.S. Cl. CPC B62D 21/155; B62D 21/02

(57) ABSTRACT

Included are a side frame extending in a front-rear direction and a lower member located outside the side frame in a vehicle width direction and extending in the front-rear direction. In the lower member, an inward inclined portion approaches the side frame as it goes away from a passenger compartment and a lower tip end portion that is a tip end portion located farthest from the passenger compartment is connected to the side frame.

### BACKGROUND OF THE INVENTION

### 1. Field of the Invention

The present invention relates to a vehicle substructure including an undercover constituting a lower surface of a vehicle body.

### 2. Description of the Related Art

In recent years, efforts have become active to provide access to sustainable transportation systems that take into account those in vulnerable positions among participants in transportation, such as elderly people, people with disabilities, and children.

To achieve this goal, there have been conducted earnest research and development to further improve traffic safety and convenience through development of collision safety performance.

Among these efforts, the study to reduce the receding of a dash panel in the event of a vehicle collision has been made.

For example, Patent Literature 1 proposes a structure in which front side frames and connecting members both extending frontward are arranged at upper and lower positions and front ends of the front side frames are connected to front ends of the connecting members via face parts.

In addition, in the structure proposed in Patent Literature 1, crash cans are arranged in front of the face parts.

Then, in the event of a vehicle front collision, the load that cannot be absorbed by the crash cans is transmitted via the face parts to the front side frames and the connecting members, and the front side frames and the connecting members absorb the load by collapsing.

### PRIOR ART DOCUMENT(S)

### Patent Literature(s)

Patent Literature 1: JP2005-231435A

### Problem to be Solved by the Invention

In the vehicle body structure proposed in Patent Literature 1, the members are configured to absorb the impact by collapsing in the front-rear direction. For this reason, in the case of an offset collision, the inert moment acts so as to rotate the vehicle toward a collision opponent.

In other words, the structure proposed in Patent Literature 1 can be said to be a technique that still has room for improvement in order to further enhance collision safety performance.

### SUMMARY OF THE INVENTION

The present invention was made in view of the above-described point, and has an object to provide a vehicle body structure capable of suppressing rotation of a vehicle in the event of an offset collision.

Accordingly, the present invention contributes to development of sustainable transportation systems.

To achieve the aforementioned object, a vehicle body structure according to the present invention includes a side frame extending in a front-rear direction; and a lower member located outside the side frame in a vehicle width direction and extending in the front-rear direction, wherein a tip end portion of the lower member which is located apart from a passenger compartment and which approaches the side frame as the tip end portion goes away from the passenger compartment in the front-rear direction is connected to the side frame.

According to the present invention, it is possible to provide a vehicle body structure capable of suppressing rotation of a vehicle in the event of an offset collision.

### BRIEF DESCRIPTION OF DRAWINGS

FIG. 1 is a plan view showing a vehicle body structure in a present embodiment.

FIG. 2 is a bottom view showing the vehicle body structure in the present embodiment.

FIG. 3 is a side view showing the vehicle body structure in the present embodiment.

FIG. 4 is an enlarged view of main parts showing how a cross member is fixed to a side frame.

FIG. 5 is an enlarged view of main parts showing how a subframe is fixed to the side frame.

FIG. 6 is an enlarged view of main parts showing how a lower tip end portion is fixed to the side frame.

FIG. 7 is an enlarged view of main parts showing a load transmitter.

FIG. 8 is an enlarged view of main parts showing the load transmitter.

FIG. 9 is a plan view showing the vehicle body structure before a collision.

FIG. 10 is a plan view showing the vehicle body structure immediately after the start of the collision.

FIG. 11 is a plan view showing the vehicle body structure in the middle of the collision.

FIG. 12 is an enlarged view of main parts showing how a lower tip end portion is fixed to a side frame in another embodiment.

### DETAILED DESCRIPTION OF THE EMBODIMENTS

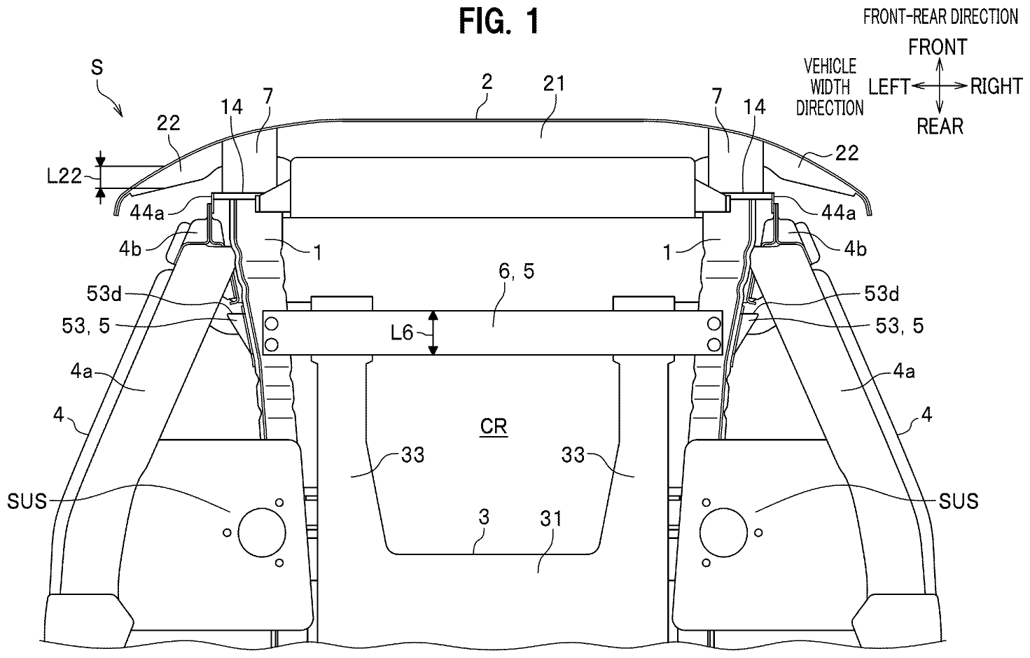

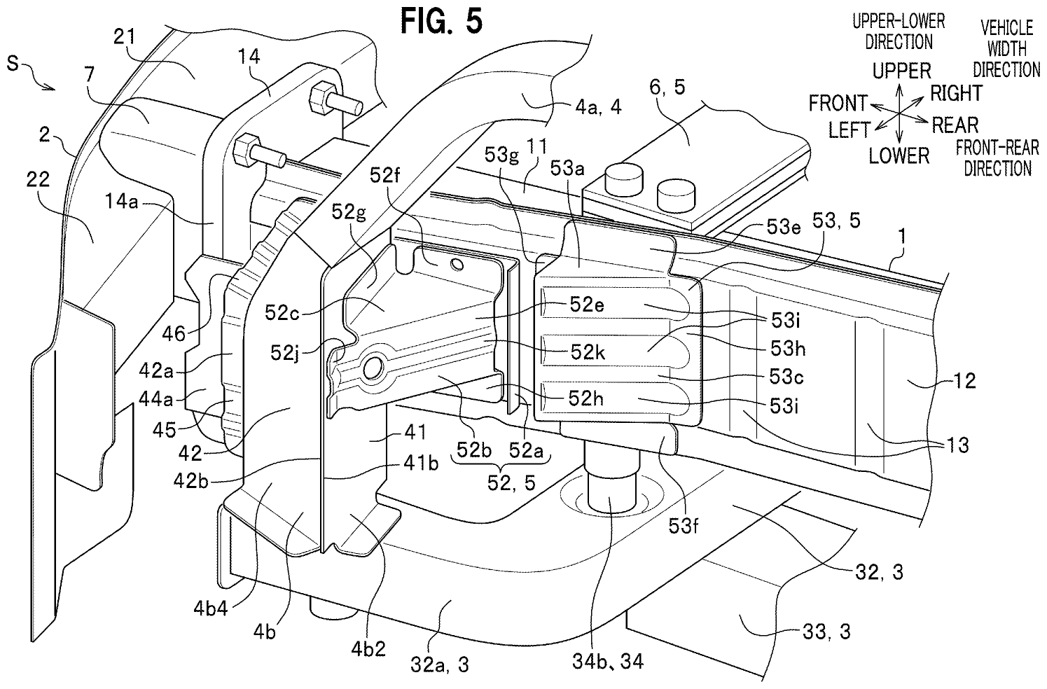

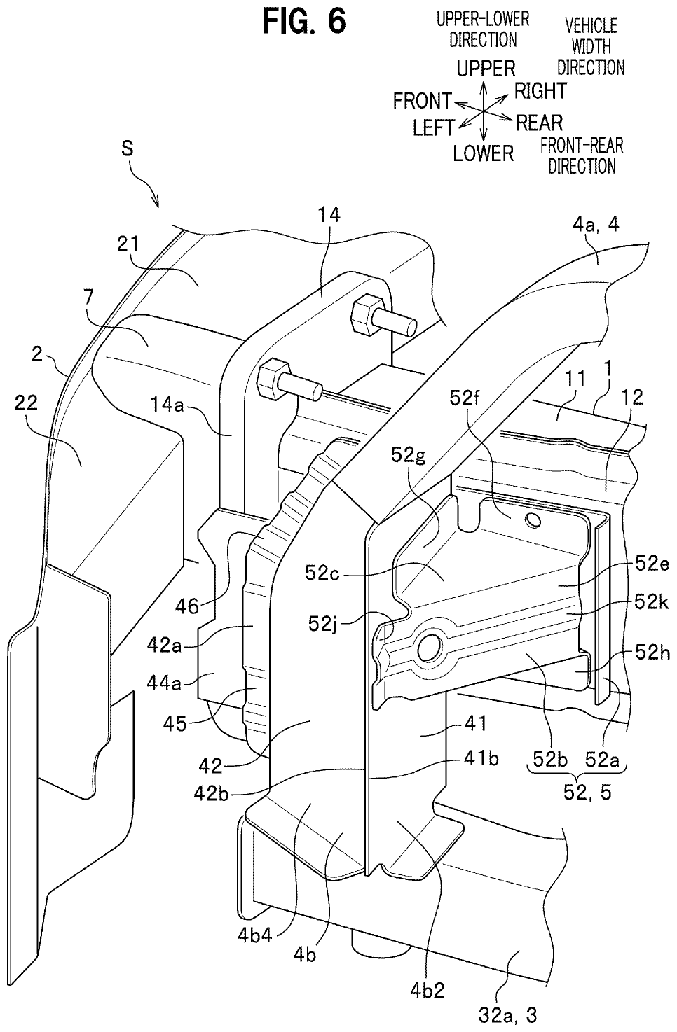

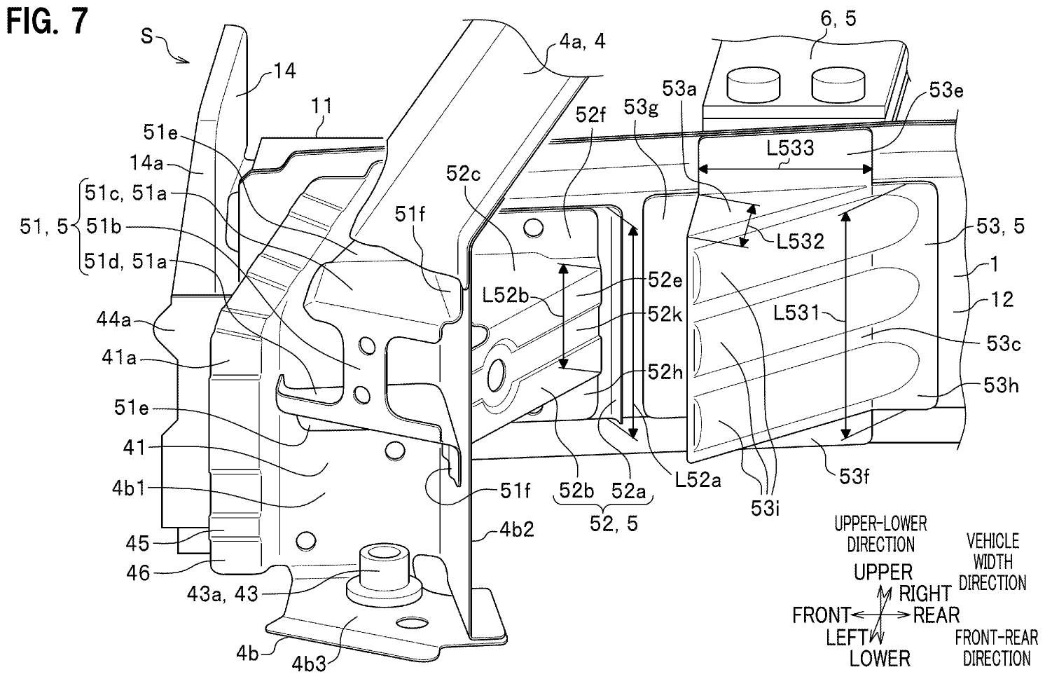

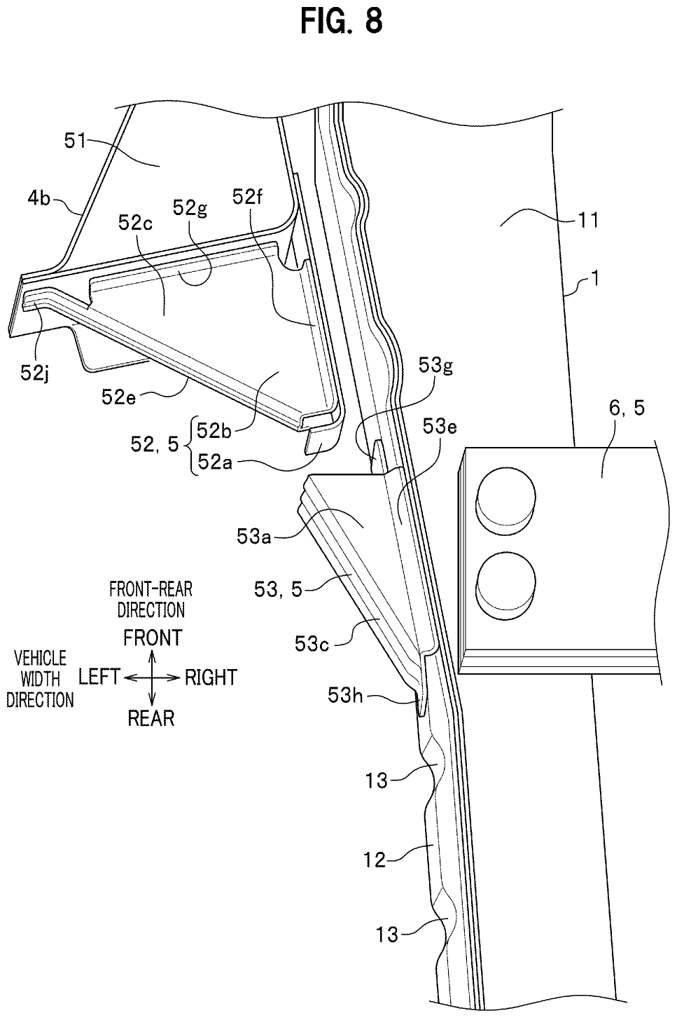

A vehicle body structure S in an embodiment of the present invention will be described in detail with reference to FIGS. 1 to 10.

In the description, the same elements will be assigned with the same reference signs, and the repetitive description thereof will be omitted.

In the following description, “front”, “rear”, “upper (up or top)”, “lower (down or bottom)”, “inner”, and “outer” respectively refer to “front” and “rear” in a vehicle front-rear direction, “upper” and “lower” in a vehicle vertical direction, and “inner” and “outer” of the vehicle inner side and the vehicle outer side, unless otherwise specified.

In a vehicle, a combustion room CR, called an engine room, for housing a power source of the vehicle such as an engine (not shown) and a motor (not shown) is located in front of a passenger compartment (not shown).

The vehicle body structure S in the present embodiment constitutes a structural part of this combustion room CR.

The vehicle body structure S is formed in a shape line-symmetric in a vehicle width direction (right-left direction).

For this reason, in the present embodiment, only the left-side structure will be described by using the drawings, while the description of the right-side structure will be omitted in some cases.

The vehicle body structure S in the present embodiment includes side frames 1, a bumper beam 2, a subframe 3, lower members 4, and a load transmitter 5 (see FIGS. 1 to 3).

The side frames 1 are a pair of right and left structural members extending along both sides of the combustion room CR in the front-rear direction.

Each side frame 1 has a cornered tube shape extending in the front-rear direction, and a tube wall thereof is formed of a corrugated plate protruding and retracting in radial directions of the cornered tube shape (in the vehicle width direction and the vertical direction).

When the side frame 1 receives an impact load in the front-rear direction due to a collision or the like, the side frame 1 absorbs the impact load by collapsing the corrugated plate portion of the tube wall.

The right and left side frames 1 are connected to each other with a cross member 6 (see FIGS. 1 to 3).

Each side frame 1 includes an extension 7 at its front end (tip end), and is connected to the bumper beam 2 via the extension 7.

The extension 7 is a structure for absorbing an impact in the event of a vehicle collision.

When receiving an impact load greater than a set value, the extension 7 crushes before the side frame 1 collapses, thereby absorbing the impact.

The cross member 6 is a structure for enhancing the rigidity of the side frames 1 in the vehicle width direction, and transmitting a load in the vehicle width direction input to one of the side frames 1 to the other side frame 1.

The cross member 6 has a cornered tube shape with a rectangular cross section.

The cross member 6 extends along the vehicle width direction, and both ends of the cross member 6 are connected and fixed to the upper surfaces of the side frames 1, respectively.

Each side frame 1 includes a side frame main body 11 and a side frame lid 12, thereby being formed in a tube shape with a substantially rectangular cross section (see FIGS. 1 to 5).

The side frame main body 11 is an elongated member having a hat-shaped cross section.

The side frame main body 11 is placed such that a groove portion in the hat shape is opened to the outside in the vehicle width direction.

In the side frame main body 11, brim portions of the hat shape are set as joint portions to be joined to the side frame lid 12.

The side frame lid 12 is an elongated member having a hat-shaped cross section with a shallower groove portion than that of the side frame body 11.

The side frame lid 12 is placed such that the groove portion in the hat shape is opened to the inside in the vehicle width direction.

In the side frame lid 12, brim portions of the hat shape are set as joint portions to be joined to the side frame main body 11.

Then, the brim portions of the side frame lid 12 and the brim portions of the side frame main body 11 are joined by spot welding or the like, so that the side frame 1 is formed in the tube shape with the substantially rectangular cross section.

Side frame beads 13 forming the corrugated plate shape of the tube wall are formed in the groove portion and the brim portions of the hat shape of each of the side frame main body 11 and the side frame lid 12.

The side frame beads 13 form corrugations in the surface of the tube wall of the side frame 1 and each extend in a circumferential direction.

The multiple side frame beads 13 are formed at predetermined intervals in the front-rear direction.

Each side frame bead 13 extends along the vertical direction and the vehicle width direction, and acts as a start point for the side frame main body 11 to crush due to an impact load.

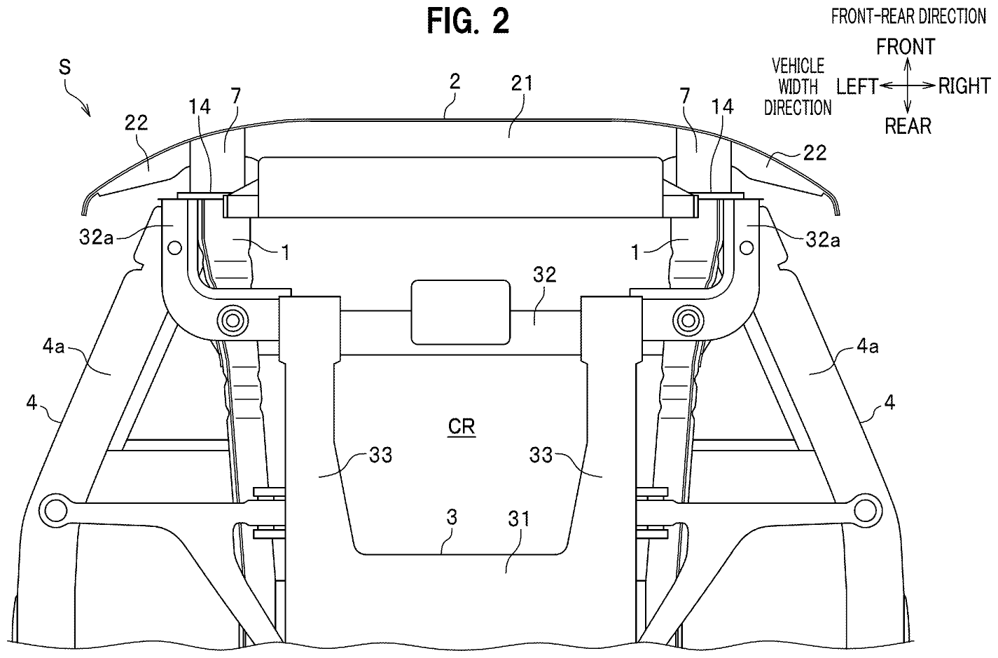

The bumper beam 2 is a structural member located at the front end portion of the combustion room CR and extending along the vehicle width direction so as to span the two extensions 7 (see FIGS. 1 and 2).

In other words, the bumper beam 2 is placed on the tip ends of the two side frames 1 via the extensions 7.

The bumper beam 2 includes a center portion 21 and overhang portions 22.

The center portion 21 is a portion between the two side frames 1.

Each overhang portion 22 is a portion overhanging from the corresponding one of the side frames 1 outward in the vehicle width direction and is a cantilever supported by the corresponding extension 7.

The overhang portion 22 is set such that a dimension in the front-rear direction (an overhang front-to-rear dimension L22) reduces as it goes outward in the vehicle width direction.

In other words, the overhang portion 22 is set such that its rigidity decreases as it goes outward in the vehicle width direction.

In the overhang portion 22, an amount of overhang from the center portion 21 is set such that the overhang portion 22 overlaps with a lower tip end portion 4b (tip end portion) of the lower member 4 in the front-rear direction when the vehicle is viewed from the front.

The subframe 3 is a structural member located below the side frames 1 (see FIGS. 2, 3, and 5).

The subframe 3 includes a subframe main body 31 and a sub-cross member 32.

The subframe main body 31 is arranged between the two side frames 1 while being located below the side frames 1.

The subframe main body 31 includes a pair of right and left subframe arms 33 extending along the front-rear direction from the passenger compartment side to the front side (the direction away from the passenger compartment).

The sub-cross member 32 extends along the vehicle width direction while overlapping with the cross member 6 in plan view, and connects front end portions of the two subframe arms 33 to each other.

At positions where the sub-cross member 32 crosses with the side frames 1 in plan view, the sub-cross member 32 is connected and fixed to the lower surfaces of the side frames 1 while leaving a predetermined space from the side frames 1.

Subframe fixtures 34 for fixing the sub-cross member 32 (subframe 3) to the side frames 1 each include a stud bolt 34a, a collar 34b, and a nut 34c.

The stud bolt 34a is a male screw protruding upward from the sub-cross member 32.

The collar 34b is a cylindrical member through which the stud bolt 34a can be inserted.

By fitting the collar 34b to the stud bolt 34a, the distance between the subframe 3 and the side frame 1 in a state where the subframe 3 is fixed to the side frame 1 is regulated at a predetermined dimension.

The stud bolt 34a is fastened to the side frame 1 with the nut 34c screwed on an upper end portion of the stud bolt 34a passing through a lower wall 11a of the side frame 1.

The position of the stud bolt 34a is set such that a front edge portion of the collar 34b and a front edge portion of the nut 34c are located at the same position in the front-rear direction as a front edge portion of the cross member 6.

This structure enables simultaneous application of a load to portions that will not crush throughout the side frame.

Note that, as long as the subframe fixture 34 at least partially overlaps with the cross member 6 in the vertical direction, the subframe fixture 34 can achieve simultaneous application of a load to the portions that will not crush throughout the side frame.

Moreover, in the case where the front edge portion of the collar 34b and the front edge portion of the nut 34c are arranged to overlap with a front end of the cross member 6 in the vertical direction as in the present embodiment, the higher effects can be obtained than in the case where only their portions overlap with each other.

Moreover, the sub-cross member 32 is bent frontward outside the side frames 1 in the vehicle width direction.

Thus, the sub-cross member 32 has a substantially U-letter shape opened to the front in plan view.

In the sub-cross member 32, sub-cross front end portions 32a constituting the portions bent frontward are connected and fixed to front end portions of the lower members 4.

The lower members 4 are structural members arranged outside the side frames 1 and the subframe 3 in the vehicle width direction (see FIGS. 1 to 7).

In side view, each lower member 4 extends along the front-rear direction from a rear-upper side to a front-lower side of the combustion room CR while curving along the shape of a tire house (not shown).

In plan view, a portion of each lower member 4 in front of a suspension fixture SUS for a front wheel is bent inward in the vehicle width direction (toward the center in the vehicle width direction) and linearly approaches the corresponding side frame 1.

Here, the portion of the lower member 4 linearly approaching the side frame 1 is referred to as an inward inclined portion 4a.

Further, in the lower member 4, the lower tip end portion 4b (tip end portion) constituting its front end portion is connected to the side frame 1 and the subframe 3.

The lower tip end portion 4b includes a lower inner plate 41 and a lower outer plate 42 and is formed to be hollow.

The lower tip end portion 4b has a bottomed cornered tube shape with a triangular cross section convex to the front side, which shape is formed by the lower inner plate 41 and the lower outer plate 42.

In other words, the dimension of the lower tip end portion 4b in the vehicle width direction is set to be larger on the front end side (the tip end side) than that on the rear end side (the passenger compartment side) in the front-rear direction.

The lower inner plate 41 constitutes an inner side surface 4b1, a rear surface 4b2, and a bottom surface 4b3 of the lower tip end portion 4b.

The lower inner plate 41 includes a lower front inner flange 41a at its front edge and a lower rear inner flange 41b at its rear edge.

The lower outer plate 42 constitutes an outer side surface 4b4 of the lower tip end portion 4b.

The lower outer plate 42 includes a lower front outer flange 42a at its front edge and a lower rear outer flange 42b at its rear edge.

The lower tip end portion 4b is formed with the lower front inner flange 41a and the lower front outer flange 42a joined together and with the lower rear inner flange 41b and the lower rear outer flange 42b joined together.

A lower front flange 45 (flange portion) is formed with the lower front inner flange 41a and the lower front outer flange 42a joined together.

Flange beads 46 are formed in the lower front flange 45.

The flange beads 46 are formed in each of the lower front inner flange 41a and the lower front outer flange 42a, and each extends in the front-rear direction while forming corrugations in the vehicle width direction.

A lower sub-fixture 43 for connecting and fixing the lower tip end portion 4b to a sub-cross front end portion 32a of the sub-cross member 32 includes a lower nut 43a and a front end bolt 43b.

Further, a lower side fixture 44 for connecting and fixing the lower tip end portion 4b to the side frame 1 includes a side frame bracket 14 and an extended piece 44a.

The lower nut 43a is placed on the bottom surface 4b3 of the lower inner plate 41 inside the lower tip end portion 4b.

The front end bolt 43b passes through the sub-cross front end portion 32a from bottom to top.

The front end bolt 43b is screwed on the lower nut 43a, so that the lower tip end portion 4b is connected and fixed to the sub-cross front end portion 32a.

The extended piece 44a is a piece extending frontward from a lower front edge portion of the lower front inner flange 41a constituting the lower front flange 45.

The side frame bracket 14 is a structure for connecting the rear end portion of the extension 7 to the front end portion of the side frame 1.

The extended piece 44a is joined to an outer side surface of the side frame bracket 14 (a bracket side surface 14a), so that the lower tip end portion 4b is connected and fixed to the side frame 1.

In other words, the lower member 4 is connected to the side frame 1 via the side frame bracket 14.

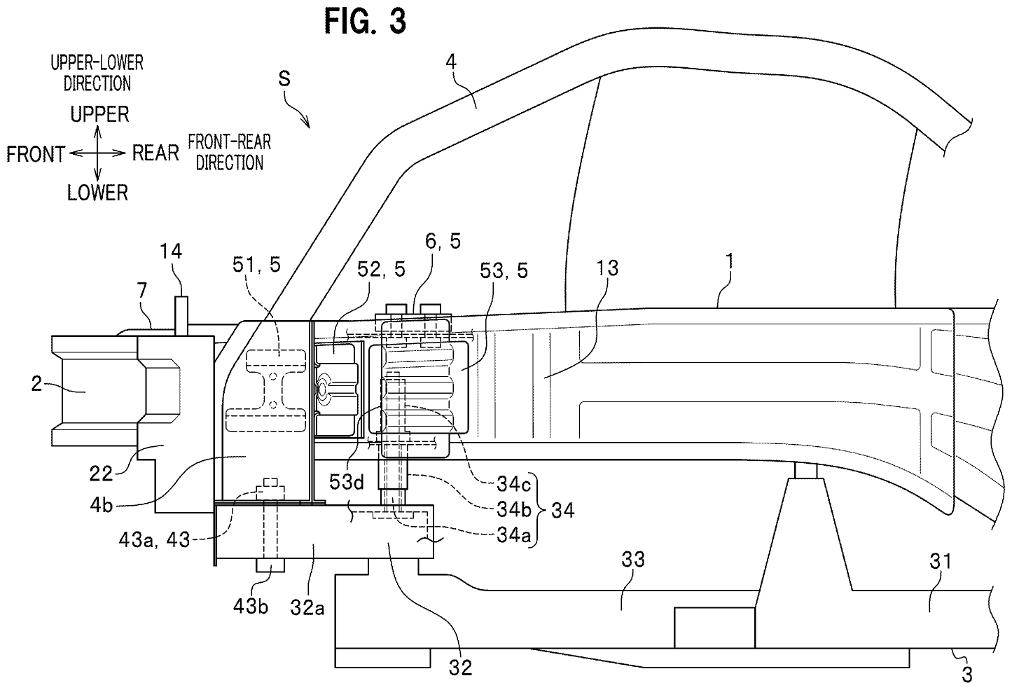

A load transmitter 5 is a structure for effectively transmitting a load input to the lower tip end portion 4b in the event of an offset collision to the side frames 1 (see FIGS. 3 to 8).

The load transmitter 5 includes a lower bulkhead 51, a load transmission member 52, a load receiver 53, and a side bulkhead 54.

The lower bulkhead 51 is a reinforcement member placed in a hollow space in the lower tip end portion 4b.

The lower bulkhead 51 hinders the lower tip end portion 4b from collapsing in the front-rear direction when the lower tip end portion 4b is pressed by the bumper beam 2 receding due to a collision.

Then, the lower bulkhead 51 transmits the impact load input from the bumper beam 2 to the load transmission member 52.

The lower bulkhead 51 includes a pair of lower load-bearing walls 51a and a lower connecting body 51b.

The pair of lower load-bearing walls 51a (a lower top load-bearing wall 51c and a lower bottom load-bearing wall 51d) are arranged substantially in parallel to each other while facing each other in the vertical direction.

The pair of lower load-bearing walls 51a are joined and fixed to the inner side surface 4b1 of the lower tip end portion 4b via their respective lower inner joint pieces 51e.

In addition, the pair of lower load-bearing walls 51a are joined and fixed to the rear surface 4b2 of the lower tip end portion 4b via their respective lower rear joint pieces 51f.

The lower connecting body 51b faces a plate surface of the lower outer plate 42, has a substantially H-letter shape, and connects vehicle widthwise outer edge portions of the lower load-bearing walls 51a to each other.

Then, the lower connecting body 51b is in contact with the outer side surface 4b4 of the lower tip end portion 4b.

In other words, the outer edge portion of each of the lower load-bearing walls 51a is in contact with the outer side surface 4b4 of the lower tip end portion 4b via the lower connecting body 51b.

The load transmission member 52 is a structure for effectively transmitting, to a vehicle widthwise outer side surface of the side frame 1, a collision load input to the lower tip end portion 4b when the lower tip end portion 4b is pushed by the bumper beam 2 and recedes and moves toward the passenger compartment (see FIGS. 3 to 8).

The load transmission member 52 is placed on the rear surface 4b2 of the lower tip end portion 4b in a manner protruding rearward.

Specifically, in plan view, the load transmission member 52 has a hollow triangular prism shape whose base coincides with the rear surface 4b2 of the lower tip end portion 4b and whose apex points rearward (toward the passenger compartment).

In order to have the aforementioned structure, the load transmission member 52 is formed of a member separate from the lower member 4.

The load transmission member 52 includes a transmission member inner wall 52a and a transmission member main body 52b.

The transmission member inner wall 52a is formed of a plate member facing in the vehicle width direction and a top-to-bottom dimension of the transmission member inner wall 52a (an inner wall top-to-bottom dimension L52a) is set to be equal to a top-to-bottom dimension of the load receiver 53 (a receiver top-to-bottom dimension L531).

In addition, in the transmission member inner wall 52a, a front end portion is fixed to the inner wall of the lower tip end portion 4b, and a rear end side projects from the lower tip end portion 4b rearward (toward the passenger compartment).

Then, a rear end portion of the transmission member inner wall 52a is bent outward in the vehicle width direction.

In the transmission member inner wall 52a, inner wall beads (not shown) are formed which form corrugations in the vehicle width direction and each extend along the front-rear direction.

The transmission member main body 52b is formed of a plate-like member machined by processing such as press working and bending, thereby having a square-cornered U-letter groove shape with triangular groove walls.

The transmission member main body 52b is placed such that the groove walls face each other in the vertical direction, the square-cornered U-letter groove is opened to an obliquely front side in a vehicle widthwise inner direction.

The square-cornered U-letter groove shape of the transmission member main body 52b is formed of a transmission upper wall 52c constituting an upper groove wall, a transmission lower wall (not shown) constituting a lower groove wall, and a transmission wall connecting body 52e constituting a groove bottom.

The transmission upper wall 52c is placed on an extension of the lower top load-bearing wall 51c.

The transmission upper wall 52c is joined to the transmission member inner wall 52a via a transmission upper joint piece 52f extending upward from a side edge portion of the transmission upper wall 52c along the front-rear direction.

The transmission upper wall 52c is joined to the rear surface 4b2 of the lower tip end portion 4b via an upper front joint piece 52g extending upward from a front edge portion of the transmission upper wall 52c along the vehicle width direction.

The transmission lower wall (not shown) is placed on an extension of the lower bottom load-bearing wall 51d.

The transmission lower wall is joined to the transmission member inner wall 52a via a transmission lower joint piece 52h extending downward from an edge portion of the transmission lower wall along the front-rear direction.

The transmission lower wall is joined to the rear surface 4b2 of the lower tip end portion 4b via a lower front joint piece (not shown) extending downward from a front edge portion of the transmission lower wall along the vehicle width direction.

The transmission wall connecting body 52e is joined to the rear surface 4b2 of the lower tip end portion 4b via a transmission front joint piece 52j extending from a front edge portion of the transmission wall connecting body 52e outward in the vehicle width direction.

In the transmission wall connecting body 52e, a bead extending along a groove direction while forming corrugations in the plate surface (a connecting body bead 52k) is formed.

In sum, a top-to-bottom dimension of the transmission member main body 52b (a main body top-to-bottom dimension L52b) is set to be smaller than the top-to-bottom dimension of the load receiver 53 (the receiver top-to-bottom dimension L531).

The load receiver 53 is a structure for effectively transmitting, to the vehicle widthwise outer side surface of the side frame 1 in collaboration with the load transmission member 52, a collision load input to the lower tip end portion 4b when the lower tip end portion 4b recedes due to a collision (see FIGS. 3 to 8).

The load receiver 53 projects from a vehicle widthwise outer surface of the side frame lid 12 outward in the vehicle width direction.

The load receiver 53 projects most outward in the vehicle width direction at its front end and the amount of the projection from the side frame lid 12 decreases as the load receiver 53 goes toward the rear.

The load receiver 53 in the present embodiment is formed of a member separate from the side frame lid 12, and is formed in a wedge shape obtained by machining a plate-like member by processing such as press working and bending.

The load receiver 53 includes a receiver upper wall 53a, a receiver lower wall (not shown), a receiver inclined wall 53c, and a receiver front wall 53d.

The receiver upper wall 53a constitutes an upper triangular wall facing in the vertical direction.

The receiver lower wall (not shown) constitutes a lower triangular wall facing in the vertical direction.

The receiver inclined wall 53c connects an outer edge portion of the receiver upper wall 53a and an outer edge portion of the receiver lower wall to each other.

The receiver front wall 53d constitutes a front surface (an end portion on a side away from the passenger compartment in the front-rear direction) of the load receiver 53, and connects a front edge portion of the receiver upper wall 53a, a front edge portion of the receiver lower wall, and a front edge portion of the receiver inclined wall 53c to each other.

The receiver front wall 53d is arranged to be located on an extension of the front surface of the cross member 6 while facing in the front-rear direction.

The receiver front wall 53d is arranged to be located on an extension of the plate surface of the transmission member inner wall 52a.

The receiver front wall 53d is arranged to overlap with the rear end portion of the load transmission member 52 when the vehicle is viewed from the front.

The load receiver 53 is joined to the vehicle widthwise outer surface of the side frame lid 12 via a receiver upper joint piece 53e, a receiver lower joint piece 53f, a receiver front joint piece 53g, and a receiver rear joint piece 53h.

The receiver upper joint piece 53e serves as an upper joint portion of the load receiver 53 and extends from an inner edge portion of the receiver upper wall 53a upward along the outer surface of the side frame lid 12.

In other words, the receiver upper joint piece 53e extends upward from the upper edge portion of the load receiver 53.

The receiver lower joint piece 53f serves as a lower joint portion of the load receiver 53 and extends from an inner edge portion of the receiver lower wall downward along the outer surface of the side frame lid 12.

In other words, the receiver lower joint piece 53f extends downward from the lower edge portion of the load receiver 53.

The receiver front joint piece 53g serves as a front joint portion of the load receiver 53 and extends from an inner edge portion of the receiver front wall 53d frontward along the outer surface of the side frame lid 12.

In other words, the receiver front joint piece 53g extends frontward from the front edge portion of the load receiver 53.

The receiver rear joint piece 53h serves as a rear joint portion of the load receiver 53 and extends from a rear edge portion of the receiver inclined wall 53c rearward along the outer surface of the side frame lid 12.

In other words, the receiver rear joint piece 53h extends rearward from the rear edge portion of the load receiver 53.

In the receiver inclined wall 53c, beads (receiver beads 53i) extending along the front-rear direction while forming corrugations in the plate surface are formed by press working.

The load receiver 53 is located behind the load transmission member 52 and arranged to overlap with the load transmission member 52 when viewed from the front of the vehicle.

The load receiver 53 is set such that its projection dimension (hereinafter referred to as a receiver projection dimension L532) is larger than its front-to-rear dimension (hereinafter, referred to as a receiver front-to-rear dimension L533).

The receiver projection dimension L532 is a dimension of the front edge portion of the load receiver 53 projecting outward in the vehicle width direction, that is, a dimension of the receiver front wall 53d along the vehicle width direction.

The receiver front-to-rear dimension L533 is a dimension of the load receiver 53 from the front edge portion to the rear edge portion, that is, a dimension between the receiver front joint piece 53g and the receiver rear joint piece 53h along the front-rear direction.

Then, the receiver front-to-rear dimension L533 is set to be equal to a dimension of the cross member 6 in the front-rear direction (hereinafter referred to as a cross width dimension L6).

In other words, the load receiver 53 is arranged, in the front-rear direction, such that its front edge is located at the same position as the front edge of the cross member 6 and its rear edge is located at the same position as the rear edge of the cross member 6.

The receiver projection dimension L532 is set to such an amount of projection that the transmission member inner wall 52a can come into contact with the wall surface of the receiver front wall 53d when the transmission member inner wall 52a recedes due to a collision or the like.

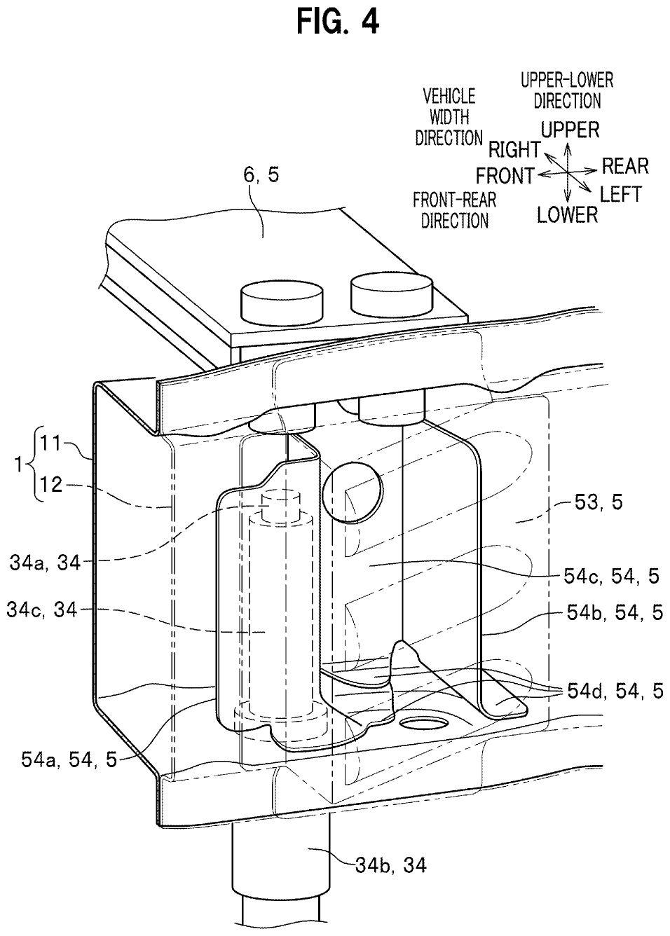

The side bulkhead 54 is a structure for efficiently transmitting a load in the vehicle width direction input to the side frame 1 to the cross member 6 while hindering the side frame 1 from collapsing in the vehicle width direction (see FIG. 4).

The side bulkhead 54 is arranged inside the tube of the side frame 1 at a position where the cross member 6 is placed.

The side bulkhead 54 includes a side front load-bearing wall 54a, a side rear load-bearing wall 54b, and a side connecting body 54c.

The side front load-bearing wall 54a is arranged at a rear edge of the stud bolt 34a so as to face in the front-rear direction and transversely cross the inside of the side frame 1.

A vehicle widthwise outer portion of the side front load-bearing wall 54a is bent and extended frontward so as to wind around the stud bolt 34a.

A lower edge portion of the side front load-bearing wall 54a is joined to a lower wall of the side frame main body 11 via a side lower joint piece 54d.

The side rear load-bearing wall 54b is arranged at the same position in the front-rear direction as the rear edge of the cross member 6 so as to face in the front-rear direction and transversely cross the inside of the side frame 1.

A lower edge portion of the side rear load-bearing wall 54b is joined to the lower wall of the side frame main body 11 via the side lower joint piece 54d.

The side connecting body 54c connects an inner edge portion of the side front load-bearing wall 54a to an inner edge portion of the side rear load-bearing wall 54b and is joined to a groove bottom portion of the side frame main body 11.

In short, the side bulkhead 54 forms a substantially U-letter shape in plan view by using the side front load-bearing wall 54a, the side rear load-bearing wall 54b, and the side connecting body 54c.

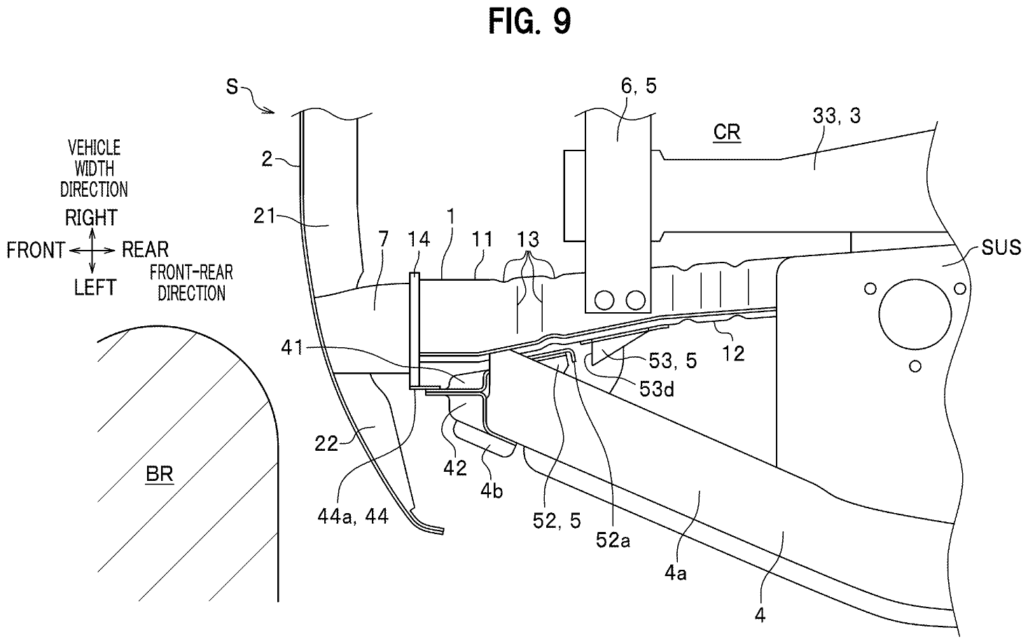

Next, description will be given of how the vehicle body structure S in the present embodiment functions when a left front part of the vehicle has an offset collision with a collision opponent BR (see FIGS. 9 to 11).

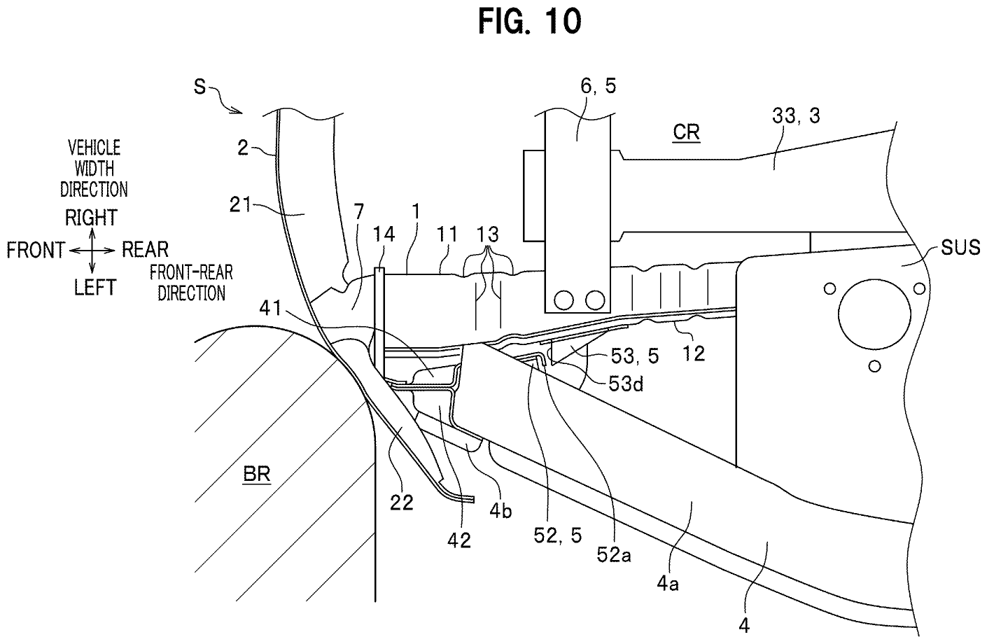

First, when the vehicle has the offset collision with the collision opponent BR, the overhang portion 22 of the bumper beam 2 recedes while the extension 7 is collapsing (see FIGS. 9 and 10).

When the overhang portion 22 recedes, the overhang portion 22 pushes the lower tip end portion 4b of the lower member 4 rearward.

The lower tip end portion 4b moves rearward while being hindered from collapsing by the lower bulkhead 51.

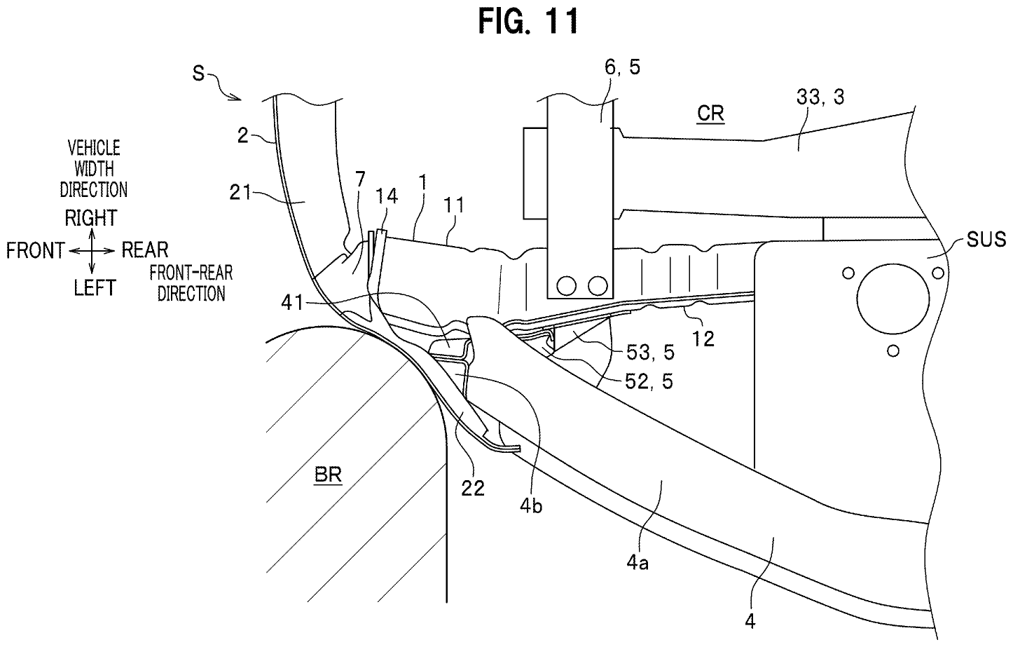

When the collision further progresses, the front end portion of the side frame 1 collapses (see FIG. 11).

The overhang portion 22 is deformed by collapsing, rides on the lower tip end portion 4b and the front surface of the inward inclined portion 4a of the lower member 4, and is further pushed rearward.

Since the lower tip end portion 4b is pushed rearward without collapsing, the load transmission member 52 and the load receiver 53 engage with each other, so that the collision load transmitted to the load transmission member 52 is transmitted to the load receiver 53.

Then, the impact load is transmitted to the side frame 1, and is also transmitted from the load receiver 53 to the side frame 1 on the vehicle right side via the side bulkhead 54, the cross member 6, and the sub-cross member 32 and thereby distributed into the right side of the combustion room CR.

As the collision progresses further, a vehicle VC moves forward while being pushed to the right in the vehicle width direction so that the collision opponent BR may move along the front surface of the inward inclined portion 4a.

Then, the force to push the vehicle VC to the right in the vehicle width direction is transmitted from the lower tip end portion 4b via the side frame 1, the cross member 6, and the sub-cross member 32 to the side frame 1 on the vehicle right side.

In other words, the vehicle VC is hindered from collapsing in the vehicle width direction and continues to move forward so as to pass by the collision opponent BR.

In contrast, in the vehicle body structure in the related art, in the event of an offset collision, the vehicle right side not hit by the collision opponent BR is left without the momentum reduced and resultantly the vehicle VC rotates toward the collision opponent BR.

Next, effects of the present embodiment will be described.

In the vehicle body structure S in the present embodiment, the lower member 4 is set to have a tapered shape in which the dimension of the lower tip end portion 4b (tip end portion) in the vehicle width direction is larger on the rear end side (the passenger compartment side) than on the front end side (the tip end side) in the front-rear direction.

This structure makes it possible to generate a load in a direction of separating the vehicle from a collision opponent in the vehicle width direction immediately after the collision start of an offset collision.

As a result, in the event of an offset collision, the vehicle can be prevented from rotating toward the collision opponent BR and move in the vehicle width direction so as to pass by the collision opponent BR.

In addition, in the vehicle body structure S in the present embodiment, the lower member 4 is provided with the inward inclined portion 4a that approaches the center in the vehicle width direction as it goes away from the passenger compartment toward the front side.

Moreover, the lower tip end portion 4b located farthest from the passenger compartment in the lower member 4 is connected to the side frame 1.

When a collision opponent hits the inward inclined portion 4a due to an offset collision, this structure makes it possible to cause a load in a direction away from the collision opponent in the vehicle width direction to act on the vehicle.

As a result, in the event of an offset collision, the vehicle can be prevented from rotating toward the collision opponent BR and move in the vehicle width direction so as to pass by the collision opponent BR.

Moreover, in the vehicle body structure S in the present embodiment, the lower member 4 is connected to the side frame 1 via the extended piece 44a constituting the lower front flange 45 (flange portion) of the lower tip end portion 4b.

This may allow the lower tip end portion 4b and the inward inclined portion 4a to be stably deformed in the event of an offset collision and thereby effectively promote a transverse movement of the vehicle.

In addition, with this structure, the dimension in the vehicle width direction of the portion of the vehicle body structure S at which the lower member 4 is connected to the side frame 1 can be made smaller than in the case where the lower member 4 is directly connected to the side frame 1.

This makes it possible to widen the inclined portion of the inward inclined portion 4a inward in the vehicle width direction and therefore facilitate the conversion of a collision load in the event of an offset collision to a load inward in the vehicle width direction.

Moreover, in the vehicle body structure S in the present embodiment, the lower member 4 is provided with the load transmission member 52 on the rear surface 4b2 of the lower tip end portion 4b. When the lower tip end portion 4b recedes (moves toward the passenger compartment) due to an offset collision, the load transmission member 52 comes into contact and engages with the load receiver 53 provided on the vehicle widthwise outer side surface of the side frame 1.

Thus, the load transmitted to the load receiver 53 from the lower tip end portion 4b can be more efficiently converted to the load in the vehicle width direction.

Further, in the vehicle body structure S in the present embodiment, the lower front flange 45 is provided with flange beads 46.

With this structure, the rigidity in the front-rear direction of the connecting portion of the lower member 4 and the side frame 1 can be enhanced more, so that the lower tip end portion 4b can be hindered from damaging immediately after the start of an offset collision.

Thus, the load transmitted to the load receiver 53 from the lower tip end portion 4b can be more efficiently converted to the load in the vehicle width direction.

In addition, in the vehicle body structure S in the present embodiment, the bumper beam 2 is set such that the rigidity of the overhang portion 22 decreases as it goes outward in the vehicle width direction.

With this structure, due to an offset collision, the overhang portion 22 is deformed along the inclination of the inward inclined portion 4a while crushing.

This allows the collision opponent BR to move more smoothly from the bumper beam 2 to the lower member 4 as the collision progresses.

Moreover, in the vehicle body structure S in the present embodiment, the overhang portion 22 is set such that the rigidity of the overhang portion 22 decreases as it goes outward in the vehicle width direction by setting the overhang front-to-rear dimension L22 to reduce as it goes outward in the vehicle width direction.

This makes it possible to reduce a step difference in the movement of the collision opponent BR from the bumper beam 2 to the lower member 4 as the collision progresses.

Furthermore, in the vehicle body structure S in the present embodiment, the lower tip end portion 4b of the lower member 4 is fixed to the subframe 3.

This enhances the rigidity of the inward inclined portion 4a and allows an offset collision to stably progress, so that a collision load can be more efficiently converted into the load inward in the vehicle width direction.

In addition, the vehicle body structure S in the present embodiment includes the extended piece 44a extending frontward (in the direction away from the passenger compartment) from the lower front edge portion of the lower front inner flange 41a constituting the lower front flange 45 (flange portion).

Then, the extended piece 44a is joined to the bracket side surface 14a of the side frame bracket 14, and thereby the lower tip end portion 4b is connected to the vehicle widthwise outer side surface of the side frame 1.

With this structure, a structure in which the lower tip end portion 4b is not directly fixed to the side frame 1 can be established.

As a result, the lower member 4 side can be deformed without being affected by the rigidity of the side frame 1, so that mode control can be easily performed.

Since the extended piece 44a is fixed to the bracket side surface 14a, the width in the vehicle width direction can be reduced as compared with the case of the fixing in the front-rear direction.

Furthermore, the presence of the extended piece 44a makes the length in the front-rear direction longer, so that a stroke from the start of a collision until reaching the lower tip end portion 4b can be increased.

This makes it possible to more effectively produce the effects obtained by setting the tapered shape in which the rear end side (the passenger compartment side) is larger than the front end side (the tip end side).

Note that although the combustion room CR set in front of the passenger compartment is structured in the vehicle body structure S in the present embodiment, the vehicle body structure is not limited to this.

For example, the present invention may be applied to a vehicle body structure in which a combustion room (not shown) is set behind the passenger compartment.

In this case, an embodiment can be carried out by replacing the front side and the rear side in the vehicle front-rear direction with each other, and the same effects as in the present embodiment can be obtained.

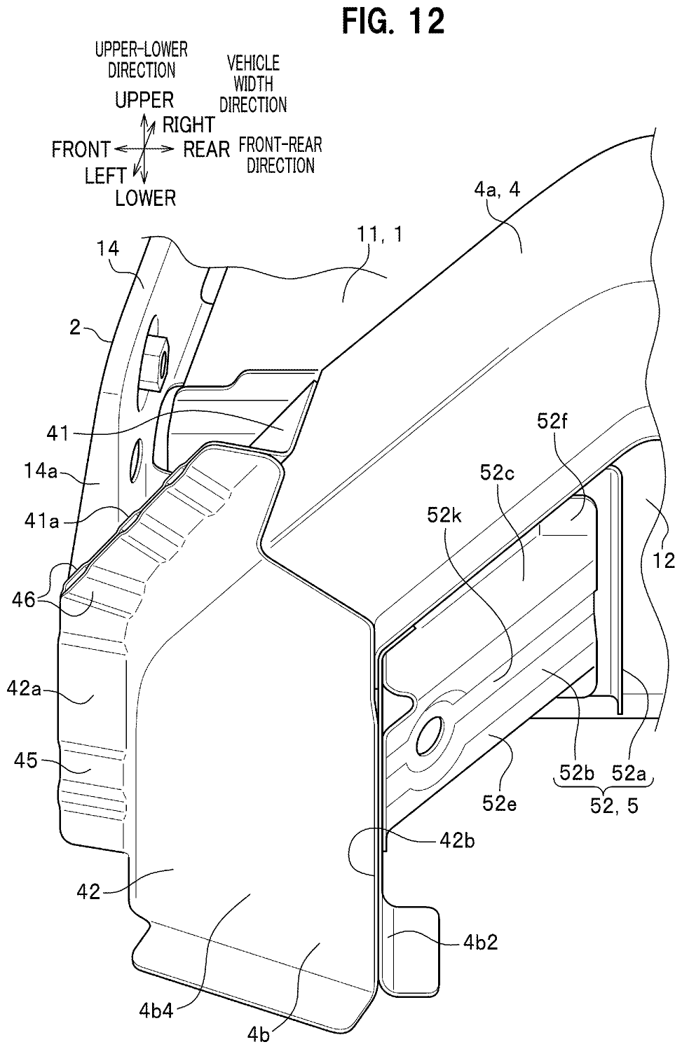

Next, another embodiment of the lower tip end portion 4b will be described (see FIG. 12).

In the description, the same elements as in the foregoing embodiment will be assigned with the same reference signs, and the repetitive description thereof will be omitted.

The lower tip end portion 4b in the present other embodiment is different from that in the foregoing embodiment in that the lower tip end portion 4b does not include the extended piece 44a.

In other words, the lower front flange 45 is connected to the bracket side surface 14a of the side frame bracket 14 directly without the extended piece 44a interposed in between.

This structure can also obtain the same effects as in the foregoing embodiment.

What is claimed is:

1. A vehicle body structure comprising:
a side frame extending in a front-rear direction; and
a lower member located outside the side frame in a vehicle width direction and extending in the front-rear direction, wherein
the lower member is set such that a tip end portion of lower member located apart from a passenger compartment has a dimension in a vehicle width direction that is larger on a passenger compartment side than on a tip end side in the front-rear direction.

2. A vehicle body structure comprising:
a side frame extending in a front-rear direction; and
a lower member located outside the side frame in a vehicle width direction and extending in the front-rear direction, wherein
a tip end portion of the lower member which is located apart from a passenger compartment and which approaches the side frame as the tip end portion goes away from the passenger compartment in the front-rear direction is connected to the side frame.

3. The vehicle body structure according to claim 1, wherein
the lower member includes a flange portion which faces in the vehicle width direction and which projects from the tip end portion along the front-rear direction, and
the lower member is connected to the side frame via the flange portion.

4. The vehicle body structure according to claim 1, wherein
the lower member includes a load transmission member which comes into contact with a vehicle widthwise outer side surface of the side frame when the lower member moves toward the passenger compartment due to an offset collision.

5. The vehicle body structure according to claim 3, wherein
the flange portion includes a bead which extends in the front-rear direction while forming a corrugation in the vehicle width direction.

6. The vehicle body structure according to claim 1, wherein
the side frame includes a bumper beam at a tip end of the side frame, the bumper beam extending in the vehicle width direction while overlapping with the lower member in the front-rear direction, and
a portion of the bumper beam outside the side frame is set to have a rigidity that decreases as the portion goes outward.

7. The vehicle body structure according to claim 6, wherein
the portion of the bumper beam outside the side frame in the vehicle width direction is set to have a dimension in the front-rear direction that reduces as the portion goes outward.

8. The vehicle body structure according to claim 1, comprising a subframe located below the side frame and fixed to the side frame, wherein
the tip end portion of the lower member is fixed to the subframe.

9. The vehicle body structure according to claim 3, wherein
the flange portion includes an extended piece that is a piece projecting in a direction away from the passenger compartment, and
the extended piece is connected to the vehicle widthwise outer side surface of the side frame.

10. The vehicle body structure according to claim 2, wherein
the lower member includes a flange portion which faces in the vehicle width direction and which projects from the tip end portion along the front-rear direction, and
the lower member is connected to the side frame via the flange portion.

11. The vehicle body structure according to claim 2, wherein
the lower member includes a load transmission member which comes into contact with a vehicle widthwise outer side surface of the side frame when the lower member moves toward the passenger compartment due to an offset collision.

12. The vehicle body structure according to claim 10, wherein
the flange portion includes a bead which extends in the front-rear direction while forming a corrugation in the vehicle width direction.

13. The vehicle body structure according to claim 2, wherein
the side frame includes a bumper beam at a tip end of the side frame, the bumper beam extending in the vehicle width direction while overlapping with the lower member in the front-rear direction, and
a portion of the bumper beam outside the side frame is set to have a rigidity that decreases as the portion goes outward.

14. The vehicle body structure according to claim 13, wherein
the portion of the bumper beam outside the side frame in the vehicle width direction is set to have a dimension in the front-rear direction that reduces as the portion goes outward.

15. The vehicle body structure according to claim 2, comprising a subframe located below the side frame and fixed to the side frame, wherein
the tip end portion of the lower member is fixed to the subframe.

16. The vehicle body structure according to claim 10, wherein
the flange portion includes an extended piece that is a piece projecting in a direction away from the passenger compartment, and
the extended piece is connected to the vehicle widthwise outer side surface of the side frame.
